(19) United States
(12) Patent Application Publication
(10) Pub. No.: US 2025/0379285 A1
(43) Pub. Date: Dec. 11, 2025

(54) BATTERY ASSEMBLY

(71) Applicant: SK On Co., Ltd., Seoul (KR)

(72) Inventors: Jin Su HAN, Daejeon (KR); Sei Hoon CHO, Daejeon (KR)

(21) Appl. No.: 19/220,097

(22) Filed: May 28, 2025

(30) Foreign Application Priority Data
Jun. 10, 2024 (KR) 10-2024-0075064
Oct. 30, 2024 (KR) 10-2024-0150979

(51) Int. Cl. H01M 10/6556; H01M 10/48; H01M 10/613; H01M 50/503

(52) U.S. Cl. CPC H01M 10/6556; H01M 10/486; H01M 10/613; H01M 50/503

(57) ABSTRACT

The present disclosure relates to a battery assembly according to an embodiment of the present disclosure includes: a plurality of battery cells, each of which includes a first tab and a second tab, arranged along a predetermined stacking direction; at least one plate arranged between the plurality of battery cells; and a flow path formed inside at least one plate through which fluid moves, wherein the at least one plate may be electrically connected to a battery cell facing at least one side among the two sides including one side and the other side respectively formed along the predetermined stacking direction.

### CROSS-REFERENCE TO RELATED PATENT APPLICATION

The present application claims priority under 35 U.S.C. § 119(a) to Korean patent application number 10-2024-0075064 filed on Jun. 10, 2024 and Korean patent application number 10-2024-0150979 filed on Oct. 30, 2024, in the Korean Intellectual Property Office, the entire disclosure of which is incorporated by reference herein.

### BACKGROUND OF THE INVENTION

### 1. Field

The present disclosure relates to a secondary battery, and more specifically, to a battery assembly.

### 2. Description of the Related Art

Secondary batteries are batteries that can be charged and discharged multiple times. Secondary batteries may be classified into battery cells and battery assemblies (e.g., battery modules, battery packs, etc.) according to their units. Battery assemblies may include multiple battery cells. Battery assemblies can be used in a variety of devices such as electric vehicles and ships. On the other hand, high-temperature heat may be generated in a specific battery cell inside the battery assembly depending on various usage environments such as rapid charging, high-power usage, or multiple charge/discharge cycles. In this case, stability problems such as increasing the temperature by transferring heat to adjacent battery cells may occur, so a technology for improving the stability of the battery assembly is required.

An embodiment of the present disclosure is to provide a battery assembly with improved stability.

The present disclosure can be widely applied in the field of green technology such as solar power generation and wind power generation. In addition, the present disclosure can be applied to environmentally friendly devices such as electric vehicles and hybrid vehicles to prevent climate change by suppressing air pollution and greenhouse gas emissions.

### SUMMARY OF THE INVENTION

A battery assembly according to an embodiment of the present disclosure may include: a plurality of battery cells, each of which includes a first tab and a second tab, arranged along a predetermined stacking direction; at least one plate arranged between the plurality of battery cells; and a flow path formed inside at least one plate through which fluid moves, wherein the at least one plate may be electrically connected to a battery cell facing at least one side among the two sides including one side and the other side respectively formed along the predetermined stacking direction.

The at least one plate may be connected to a first tab of a battery cell facing one side of the two sides or a first tab of a battery cell facing the other side of the two sides, or a second tab of a battery cell facing one side of the two sides or a second tab of a battery cell facing the other side of the two sides.

The at least one plate may include a cooling portion in which the flow path is formed and side portions positioned at both ends of the cooling portion.

The at least one plate may be electrically connected to the first tab or the second tab of the battery cell facing at least one side of the two sides at the cooling portion.

The at least one plate may be electrically connected to the first tab or the second tab of the battery cell facing at least one side of the two sides at the side portion.

Each of the plurality of battery cells may include a body portion to which the first tab and the second tab are respectively connected and in which the electrode assembly is accommodated, wherein at least one side of two sides of the body portion formed along the stacking direction may be in contact with the at least one plate.

The body portion may be contact with the cooling portion of the at least one plate.

At least one surface in contact with at least one plate in the body portion may be insulated.

The side portion may include a first side end portion formed at one side end along a direction perpendicular to the stacking direction and a second side end portion formed at the other side end facing the one side end.

The cooling portion may be formed between the first side end portion and the second side end portion.

One of the first side end portion and the second side end portion of the at least one plate may include one of an inlet through which the fluid is injected and an outlet through which the fluid is discharged.

The flow path may be in communication with the inlet and the outlet.

The inlet and the outlet may be formed at the first side end portion, and the flow path includes a first flow path communicating with the inlet and moving the fluid from the first side end portion toward the second side end portion and a second flow path that communicates the first flow path and the outlet to move the fluid.

A battery assembly according to an embodiment of the present disclosure may further include a supply pipe for supplying the fluid to the inlet; and a discharging pipe for moving the fluid discharged from the outlet.

The at least one plate may be formed of a plurality of plates, and the plurality of plates are connected to the supply pipe and the discharging pipe.

The first tab may include a first bending portion, at least a portion of which is bent toward one side of one of the at least one plates and a first connecting portion that is bent at the first bending portion and is extended in parallel with one side of the plate.

The first connecting portion may be electrically connected to one side of the plate.

The second tab may include a second bending portion, at least a portion of which is bent in a direction opposite to the direction in which the first bending portion is bent and a second connecting portion which is bent in the second bending portion in a direction opposite to the first connecting portion and is extended parallel to the one side of the plate.

The second connecting portion may be electrically connected to the other side of the other of the at least one plate.

A battery assembly according to an embodiment of the present disclosure may further include a sensing terminal coupled to the at least one plate to be electrically connected to the at least one plate and be configured to sense voltages or currents of the plurality of battery cells.

The sensing terminal may detect the temperature of the plurality of battery cells, communicates with a sensor that detects the presence or absence of gas generation or pressure in a space where the plurality of battery cells are arranged, and detects thermal runaway of the plurality of battery cells.

A battery assembly according to an embodiment of the present disclosure may further include a case forming an accommodation space for accommodating the plurality of battery cells and the at least one plate, wherein the case may further include an endplate arranged between the plurality of battery cell and the case along the stacking direction inside the case.

At least a portion of the inner surface of the accommodation space may be insulated.

A battery assembly according to an embodiment of the present disclosure may further include a high-voltage terminal portion electrically connecting the plurality of battery cells and the outside of the case in the end plate.

According to an embodiment of the present disclosure, a battery assembly with improved stability may be provided.

According to an embodiment of the present disclosure, the thermal stability of the battery assembly may be improved.

According to an embodiment of the present disclosure, it is possible to improve the cooling performance of the battery assembly.

According to an embodiment of the present disclosure, the performance of the battery assembly may be improved according to the cooling performance.

According to an embodiment of the present disclosure, it is possible to improve a contact area for cooling a battery cell.

According to an embodiment of the present disclosure, it is possible to minimize a decrease in the density of battery cells in the battery assembly in order to cool the battery cells.

### BRIEF DESCRIPTION OF THE DRAWINGS

FIG. 1 is a diagram for explaining a battery assembly according to an embodiment.

FIG. 2 is a diagram illustrating a battery cell according to an embodiment.

FIG. 3 is a diagram illustrating a plate according to an embodiment.

FIG. 4 is a diagram illustrating a combination of a battery cell and a plate according to an embodiment.

FIG. 5 is a diagram illustrating a sensing terminal according to an embodiment.

FIG. 6 is a diagram illustrating a connection relationship between battery cells according to an embodiment.

FIG. 7 is a diagram illustrating a connection relationship between battery cells according to another embodiment.

FIG. 8 is a diagram illustrating a connection relationship between battery cells according to another embodiment.

FIG. 9 is a schematic diagram illustrating a connection relationship between a battery cell and a side end portion according to another embodiment.

FIG. 10 is a schematic diagram illustrating a connection relationship between a battery cell and a cooling portion according to another embodiment.

### DETAILED DESCRIPTION

Hereinafter, referring to the accompanying drawings, embodiments of the present disclosure are described in detail so that those skilled in the art to which the present disclosure pertains can easily practice them. However, the present disclosure may be implemented in a number of different forms and is not limited to the embodiments described herein. Further, in order to clearly explain the present disclosure in the drawings, parts that are not related to the explanation are omitted, and similar parts are given similar reference numerals throughout the specification.

Throughout the specification, when it is mentioned that a part is “connected” to another part, it includes not only the case where they are “directly connected,” but also the case where they are “electrically connected” with another element in between.

Throughout the specification, when it is mentioned that an element is “on” another element, this includes not only the case where the element is in contact with the other element, but also the case where there is another element between the two elements.

Throughout the specification, when it is mentioned that a part “includes” or “comprises” a component, this does not mean that it excludes other components, but rather that it may include other components, unless otherwise specifically stated. The terms such as “about” and “substantially”, which indicate degrees, as used throughout the specification, are used in a meaning that is at or near a numerical value when manufacturing and material tolerances inherent in the meanings stated are given, and are used to prevent unscrupulous infringers from unfairly exploiting the disclosure, which states precise or absolute numbers to aid understanding of the present disclosure. The terms “step of doing ˜” or “step of ˜” as used throughout the specification do not mean “step for ˜”.

Hereinafter, with reference to the accompanying drawings and the description below, preferred embodiments of the present disclosure are described in detail. However, the present disclosure is not limited to the embodiments described here, but may be embodied in other forms. Throughout the specification, the same reference numerals represent the same components.

In the following, a battery cell according to an embodiment of the present disclosure will be described.

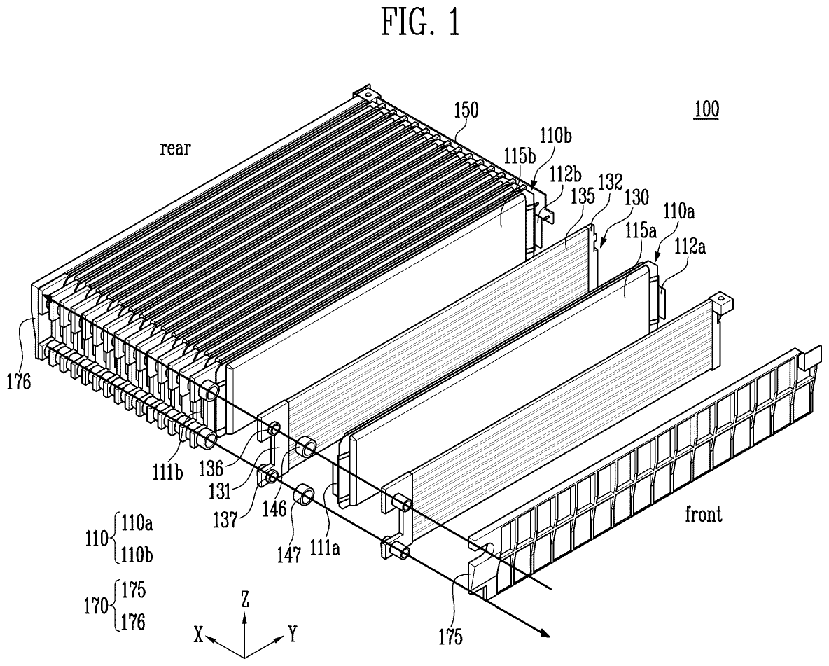

FIG. 1 is a diagram for explaining a battery assembly according to an embodiment.

Referring to FIG. 1, a battery assembly 100 according to an embodiment may include a plurality of battery cells 110 and at least one plate 130. For example, the battery assembly 100 may correspond to various types of energy storage devices such as a battery module, a battery pack, or an energy storage system (ESS). The battery assembly 100 may supply electrical energy to an external device. The battery assembly 100 may be supplied with electrical energy from an external power source. The battery assembly 100 according to an embodiment may further include a sensing terminal 150. The battery assembly 100 according to an embodiment may further include a case 170.

Each of the plurality of battery cells 110 may be a secondary battery capable of being charged and discharged multiple times. For example, the secondary battery may be one of various types such as a lithium ion battery, a lithium polymer battery, a nickel hydrogen battery, a nickel cadmium battery, a sodium battery, and an all-solid-state battery. A plurality of battery cells 110 may be arranged along the stacking direction. For example, the stacking direction may be a first horizontal direction (e.g., an X-axis direction). The number of battery cells 110 may be two or more.

The plurality of battery cells 110 may include one battery cell 110a and another battery cell 110b. The plurality of battery cells 110 may further include battery cells 110 other than one battery cell 110a and another battery cell 110b.

The plurality of battery cells 110 may include a first tab 111 and a second tab 112, and may be arranged along a predetermined stacking direction.

One battery cell 110a and another battery cell 110b may be battery cells disposed adjacent to each other in a first horizontal direction or stacking direction (e.g., x-axis direction) among a plurality of battery cells 110. Hereinafter, the stacking direction is referred to as the first horizontal direction.

Each battery cell 110 may include a first tab 111 and a second tab 112, the first tab 111 may correspond to a positive tab or a negative tab, and the second tab 112 may correspond to a tab having a pole different from that of the first tab 111. One battery cell 110a may include a first tab 111a and a second tab 112a. One battery cell 110a may further include a body portion 115a. In embodiments, the first tab 111a and the second tab 112a may protrude from the body portion 115a in a direction perpendicular to the second horizontal direction or stacking direction (e.g., the y-axis direction). Hereinafter, a direction perpendicular to the direction of the right side is referred to as a second horizontal direction.

The other battery cell 110b may include a first tab 111b and a second tab 112b. The other battery cell 110b may further include a body portion 115b. In an embodiment, the first tab 111b and the second tab 112b may protrude from the body portion 115b in a second horizontal direction (e.g., the y-axis direction).

In an embodiment, the body portion 115a of one battery cell 110a and the body portion 115b of another battery cell 110b may face each other in a first horizontal direction (e.g., the x-axis direction). Specifically, one battery cell 110a and another battery cell 110b may be disposed such that the body portion 115a of one battery cell 110a and the body portion 115b of another battery cell 110b face each other.

In an embodiment, a first tab 111b of another battery cell 110b may face a first tab 111a of one battery cell 110a, and a second tab 112b of the other battery cell 110b face a second tab 112 of one battery cell 210a. That is, the one battery cell 110a and the other battery cell 110b may be arranged such that the first tab 111a of the one battery cell 1110a and the first tab 111b of the other battery cell 1110b face each other, and the second tab 112a of the one batteries cell 110a and second tab 112b of the other batteries cell 110b face each other. In this case, the first tab 111a and the first tab 111b protrude in the same direction as each other, and the second tab 112a and the second tab 121b may protrude in the same directions as each other.

The plate 130 may be arranged between the plurality of battery cells 110. Embodiments may include at least one plate 130, each arranged between a plurality of battery cells 110.

In an embodiment, the number of plates 130 included in the battery assembly 100 may be plural. In an embodiment, the plurality of plates 130 may be disposed one by one between adjacent battery cells among the plurality of battery cells 110. In this case, the number of plates 130 may be one less than the number of battery cells 110.

In an embodiment, the surface of the plate 130 may be coated with an insulating material. Insulating materials are materials with electrical insulation properties. The insulating material may be, for example, mica, plastic, rubber, silicone, etc.

The at least one plate 130 may be electrically connected to the first tab 111a of one battery cell 110a on one side or the other side of the two sides including one side and the other side respectively formed along the stacking direction, or electrically connected to the second tab 112b of the other battery cell 110b on one side or on the other side.

The at least one plate 130 may be electrically connected to the first tab 111a of one battery cell 110a on at least one of the two sides including one side and the other side formed along the stacking direction, and electrically connected to the second tab 112b of the other battery cell 110b on the other side.

In one embodiment, the at least one plate 130 may be electrically connected with a first tab 111a of a battery cell facing one of the two sides or a first tab 111a of a battery cell opposite the other of the two sides, or may be electrically connected to a second tab 112b of a battery cell opposing one of the two surfaces or a second tab 112b of a battery cell opposed to the other of the two sides.

The plate 130 may be arranged between one battery cell 110a and another battery cell 110b. The plate 130 may electrically connect one battery cell 110a and another battery cell 110b to each other. The plate 130 may be electrically connected to the first tab 111 and the second tab 112.

In an embodiment, the plate 130 may cool at least one of one battery cell 110a and another battery cell 110b. In an embodiment, the plates 130 may be in contact with opposing surfaces of one battery cell 110a and another battery cell 110b, respectively. The plate 130 may cool the heat generated in at least one of the one battery cell 110a and the other battery cell 110b by using coolant. Accordingly, the temperature of one battery cell 110a and the temperature of the other battery cell 110b can be maintained at an appropriate temperature.

According to the present disclosure, a separate busbar member that extends in a first horizontal direction in which the plurality of battery cells 110 are stacked at side ends of the plurality of battery cell 110 and electrically connects the plurality of battery cells 110 may be omitted. According to the present disclosure, it is possible to provide the battery assembly 100 with improved cooling performance and space efficiency.

In an embodiment, the sensing terminal 150 may be coupled to the plate 130 to be electrically connected to the plate 130. The sensing terminal 150 may be electrically connected to the plate 130 to measure the voltage of one battery cell 110a and another battery cell 110b.

In an embodiment, the case 170 may receive a plurality of battery cells 110 and at least one plate 130. For example, a receiving space may be formed inside the case 170. A plurality of battery cells 110 and at least one plate 130 may be accommodated in the accommodation space.

At least a part of the inner side of the receiving space may be insulated. The accommodation space may be electrically disconnected from the plurality of battery cells 110 and the at least one plate 130 accommodated therein.

In embodiments, case 170 may include at least one of endplates 175, 176, side covers, bottom covers, and top covers. In embodiments, the endplates 175, 176, side covers, bottom covers, and top covers may be joined to each other by welding, bolting, or the like. The endplates 175, 176 may be disposed with a plurality of battery cells 110 interposed therebetween in a first horizontal direction (e.g., x-axis direction).

The endplates 175, 176 may be arranged between the plurality of battery cells 110 and the case 170 along a stacking direction (e.g., the x-axis direction) within the case 170.

The endplates 175, 176 may include high voltage terminals that electrically connect the plurality of battery cells 110 and the exterior of the case 170.

The side cover may be arranged with a plurality of battery cells 110 interposed therebetween in the second horizontal direction (e.g., y-axis direction). The lower cover and the upper cover may be disposed with a plurality of battery cells 110 interposed therebetween in the height direction (e.g., the z-axis direction). Here, the first horizontal direction (for example, the x-axis direction), the second horizontal direction (for instance, the y-axis direction), and the height direction (for instance the z-axis direction) may be directions perpendicular to each other.

Hereinafter, one of the plurality of battery cells 110 will be described.

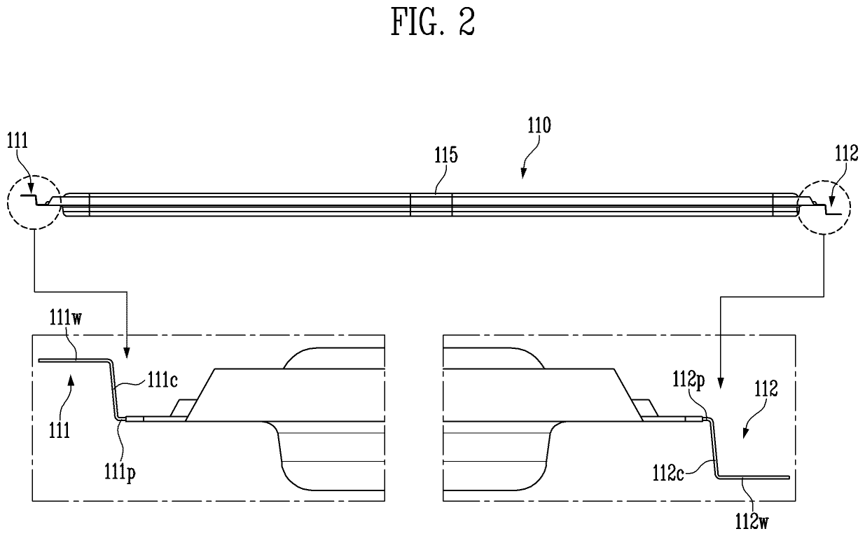

FIG. 2 is a diagram illustrating a battery cell according to an embodiment.

Referring to FIG. 2, the battery cell 110 may include a body 115 and an electrode tab. Specifically, the plurality of battery cells 110 may include a body 115 to which the first tab 111 and the second tab 112 are connected and in which the electrode assembly is accommodated. At least one of the two sides of the body portion 115 formed along the stacking direction (e.g., the x-axis direction) may be in contact with the at least one plate 130.

The body 115 may include an electrode assembly, an electrolyte, and an exterior material. Electrode assemblies may include negative electrodes and positive electrodes having different electrical polarities. The negative electrode and positive electrode may be alternately stacked. Negative electrodes and positive electrodes can convert chemical energy into electrical energy through redox reactions.

In an embodiment, the electrode assembly may further comprise a separator. The separator may be arranged between the negative electrode and positive electrode so that the negative electrode and positive electrode do not come into contact with each other. A portion of the electrode tab may be located inside the exterior material, and another portion of the electrode tap may protrude to the outside of the exterior material. The electrolyte may be a medium that transfers ions or current between the positive and negative electrodes. The exterior material may contain an electrode assembly.

In an embodiment, the exterior material may comprise a pouch film. In this case, a part of the exterior material may be sealed while the electrode assembly is accommodated in the inner space of the exterior material. In an embodiment, the pouch film may comprise at least one of nylon, aluminum, and chlorinated polypropylene.

Meanwhile, the above-described embodiment is only an embodiment, and the exterior material may have various shapes such as a square shape or a cylindrical shape, and the exterior materials may be implemented to include various materials such as aluminum, an alloy material, and a composite material.

The electrode tab may include a first tab 111 and a second tab 112 having different electrical polarities. The first tab 111 may include a first bending portion 111c, at least a portion of which is bent toward one side of one plate 130 of the at least one plate 130, and a first connecting portion 111w, which is bent at the first folded portion 111c and extends in parallel with one side of the one plate 130.

The first connecting portion 111w may be electrically connected to one side of one plate 130.

The second tab 112 may include a second bending portion 112c, at least a portion of which is bent in a direction opposite to a direction in which the first bending portion 111c is bent, and a second connecting portion 112w, which is bent in the direction opposite to the first connecting portion 111w at the second bending portion 112c and extends side by side with one side.

The second connecting portion 112w may be electrically connected to the other side of the other plate 130 of the at least one plate 130.

Hereinafter, the first tab 111 is assumed to be a positive electrode tab and the second tab 112 is assumed to be a negative electrode tab, but the polarities of the first tab 111 and the second tabs 112 are not limited thereto.

The electrode tab may include a positive electrode tab and a negative electrode tab having different electrical polarities. The positive electrode tab may be electrically connected to the positive electrode of the electrode assembly, and the negative electrode tab may be electrically connectable to the negative electrode of the electrode assembly.

In an embodiment, the positive and negative tabs may be bent. For example, the number of bending times of each of the positive electrode tab and the negative electrode tab may be one or more times. The bent angle may be 90 degrees, but is not limited thereto and may be modified to various values.

In an embodiment, the positive tab and the negative tab may protrude from different side ends of the body portion 115. For example, the positive tab and the negative tab may protrude one by one from each of both ends of the body portion 115 in the second horizontal direction (e.g., the y-axis direction). In other embodiments, the positive tab and the negative tab may protrude from the same side end of the body portion 115.

In an embodiment, the positive electrode tab may include at least one of a positive electrode protruding portion 111p, a positive electrode bending portion 111c, and a positive electrode connecting portion 111w. The positive electrode protruding portion 111p may be a portion of a positive electrode tab protruding from the body portion 115 toward the outside.

For example, the positive electrode protrusion 111p may extend in a second horizontal direction (e.g., the y-axis direction). The positive connecting portion 111w may be a portion of a positive tab spaced apart from the positive protruding portion 111p in a first horizontal direction (e.g., the x-axis direction). The positive connection 111w may extend in a second horizontal direction (e.g., the y-axis direction). The positive electrode bending portion 111c may connect between the positive electrode protruding portion 111p and the positive electrode connecting portion 111w. The positive connection 111w may include an area welded to the plate.

In an embodiment, the positive electrode protruding portion 111p, the positive electrode bending portion 111c, and the positive electrode connecting portion 111w may be integrally formed. The positive electrode bending portion 111c may be a portion that is bent and extends at an end portion of the positive electrode protruding portion 111p. The positive connecting portion 111w may be a portion that is bent and extends at an end portion of the positive bending portion 111c.

In an embodiment, the negative electrode tab may include at least one of a negative electrode protruding portion 112p, a negative electrode bending portion 112c, and a negative electrode connecting portion 112w. The negative electrode protruding portion 112p may be a portion of a negative electrode tab protruding outward from the body portion 115.

For example, the negative electrode protruding portion 112p may extend in a second horizontal direction (e.g., the y-axis direction). The negative electrode connecting portion 112w may be a portion of a negative electrode tab spaced apart from the negative electrode protrusion portion 112p in a first horizontal direction (e.g., the x-axis direction). The negative electrode connecting portion 112w may extend in a second horizontal direction (e.g., the y-axis direction).

The negative electrode bending portion 112c may connect between the negative electrode protruding portion 112p and the negative electrode connecting portion 112w. The negative electrode connecting portion 112w may include an area welded to the plate. Meanwhile, the plate welded to the negative electrode connecting portion 112w and the plate welded to the positive electrode connecting portion 111w may be different plates.

In an embodiment, the negative electrode protruding portion 112p, the negative electrode bending portion 112c, and the negative electrode connecting portion 112w may be integrally formed. The negative electrode bending portion 112c may be a portion that is bent and extends from an end portion of the negative electrode protruding portion 112p. Here, a direction in which the positive electrode bending portion 112c extends may be opposite to a direction in which a positive electrode bending portion 111c extends.

For example, the negative electrode fold 112c may extend in the −x-axis direction and the positive electrode fold 111c in the +x-axis direction. The negative electrode connecting portion 112w may be a portion that is bent and extends from an end portion of the negative electrode bending portion 112c. Here, a direction in which the negative electrode connecting portion 112w extends may be opposite to a direction in which a positive electrode connecting portion 111w extends. For example, the negative electrode connecting portion 112w may extend in the +Y-axis direction, and the positive electrode connecting portion 111w may extend in a −Y-axis direction.

The description of battery cell 110 in FIG. 2 may apply equally to one battery cell 110a and the other battery cell 110b in FIG. 1.

In an embodiment, referring to FIGS. 1 and 2, one battery cell 110a, a plate 130, another battery cell 110b, and another plate may be sequentially disposed in the +X-axis direction. Here, the plate 130 may be arranged between one battery cell 110a and another battery cell 110b.

The at least one plate 130 may include a cooling portion 135 in which a flow path is formed and side ends located at both ends of the cooling portion 135.

For example, the plate 130 may include a first side end portion 131, a second side end portion 132, and a cooling portion 135.

In an embodiment, the cooling portion 135 is manufactured by an extrusion method, and the first side end portion 131 and the second side end portion 132 may be manufactured by a die casting or processing method. The first side end portion 131 and the second side end portion 132 may extend from both ends of the cooling portion 135, respectively. Other plates may include the same configuration as plate 130.

The cooling portion 135 may be formed between the first side end portion 131 and the second side end portion 132.

In an embodiment, one battery cell 110a may include a first tab 111a and a second tab 112a. The first tab 111a of the battery cell 110a may include at least one of a first positive electrode protruding portion, a first positive electrode bending portion, and a first positive electrode connecting portion. In an embodiment, the first positive electrode cut may extend toward the first side end portion 131 of the plate 130.

For example, when the plate 130 is disposed in the +X-axis direction in one battery cell 110a, the first positive electrode bending portion of the one battery cell 110a may extend in the +X axis direction. The first positive connection of one battery cell 110a may be bent at a first positive fold and extend in a second horizontal direction (e.g., the Y-axis direction). For example, if the first positive electrode bending portion extends in the +X-axis direction, the first positive electrode connecting portion may be bent at the end of the first positive electrode bending portion to extend in the −Y-axis direction.

The second tab 112a of the battery cell 110a may include at least one of a first negative electrode protruding portion, a first negative electrode bending portion, and a first negative electrode connecting portion. In an embodiment, the first cathodic fold may extend in a direction opposite to the first anodic fold.

For example, when the first positive electrode bending portion extends in the +X-axis direction, the first negative electrode bending portion may extend in the −X-axis direction. The first negative electrode connection may be bent at the first negative electrode fold and extend in a second horizontal direction (e.g., the Y-axis direction).

For example, when the first negative electrode fold extends in the −X-axis direction, the first negative electrode connecting portion may be bent at the end of the first negative electrode crease to extend in the +Y-axis direction.

In an embodiment, another battery cell 110b may include a first tab 111b and a second tab 112b.

The first tab 111b of the other battery cell 110b may include at least one of a second positive electrode protruding portion, a second positive electrode bending portion, and a second positive electrode connecting portion. In an embodiment, the second positive electrode cutout may extend in the same direction as the first positive electrode cutout of one battery cell 110a. Alternatively, the second positive electrode cut may extend towards the first lateral end of the other plate.

Alternatively, the second positive electrode bending portion may extend in the opposite direction to the second negative electrode bending portion. The second positive electrode connection may be bent at the second positive electrode fold and extend in a second horizontal direction (e.g., the Y-axis direction).

The second tab 112b of the other battery cell 110b may include at least one of a second negative electrode protruding portion, a second negative electrode bending portion, and a second negative electrode connecting portion. The second cathodic bend may extend toward the second side end portion 132 of the plate 130. For example, when the plate 130 is disposed in the −X-axis direction in another battery cell 110b, the second negative electrode bending portion of the other battery cell 110b may extend in the −x-axis direction. The second negative electrode connection may be bent at the second negative electrode fold and extend in a second horizontal direction (e.g., the Y-axis direction).

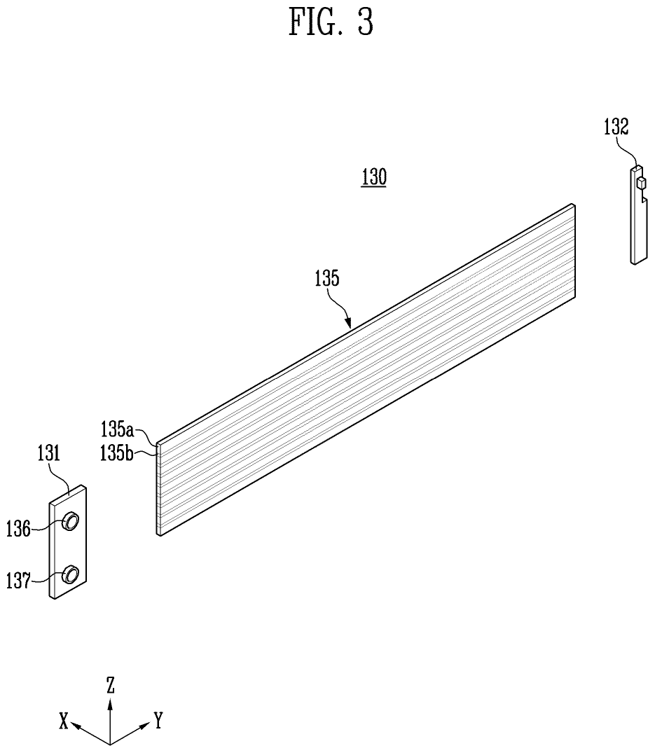

FIG. 3 is a diagram illustrating a plate according to an embodiment.

Referring to FIGS. 1 and 3, a plate 130 according to an embodiment of the present disclosure may include at least one of a first side end portion 131, a second side end portion 132, and a cooling portion 135. In an embodiment, at least one of the first side end portion 131, the second side end portion 132, and the cooling portion 135 may include an aluminum material.

The body portion 115 may be in contact with a cooling portion 135 in which a flow path is formed in the at least one plate 130. At least one surface of the body portion 115 in contact with the at least one plate 130 may be insulated.

The cooling portion 135 according to an embodiment may be in contact with the body 115a of one battery cell 110a and the body 115b of another battery cell 110b. The cooling portion 135 may cool one battery cell 110a and another battery cell 110b.

In an embodiment, the cooling portion 135 may include a flow path. The flow path may be a passage through which coolant moves.

The flow path may communicate with an inlet 136 and an outlet 137, which will be described below.

In an embodiment, the flow path may comprise a plurality of tubes. The plurality of tubes may include a first flow path 135a and a second flow path 135b. The shape of the flow path or pipe can be variously modified and implemented.

In an embodiment, each of the plurality of flow paths may extend in a second horizontal direction (e.g., the Y-axis direction). For example, the first flow path 135a and the second flow path 135b may extend in a second horizontal direction (e.g., the Y-axis direction). Each of the plurality of flow paths may be spaced apart from each other in a height direction (e.g., Z-axis direction). For example, the first flow path 135a and the second flow path 135b may be separated from each other by being spaced apart in the height direction (e.g., the Z-axis direction).

In an embodiment, the first side end portion 131 and the second side end portion 132 may protrude in a second horizontal direction (e.g., the Y-axis direction) at both ends of the cooling portion 135. The second horizontal direction (e.g., Y-axis direction) may be a direction perpendicular to the first horizontal direction (e.g., X-axis direction).

The at least one plate 130 may include a first side end portion 131 formed at one end along a direction perpendicular to the stacking direction (e.g., the Y-axis direction) and a second side end portion 132 formed at the other end facing the one end.

In an embodiment, the second side end portion 132 may include a bend connected to the first flow path 135a and the second flow path 135b such that coolant moves from the first flow path 135a to the second flow path 135b. That is, the coolant in the first flow path 135a may move into the second flow path 135b through the bending portion. The second side end portion 132 may control or return the flow of coolant. The number of times the second side end portion 132 returns the coolant may be one or more times. Accordingly, the temperature variation inside the battery cell can be minimized.

In an embodiment, the first side end portion 131 may include an inlet 136 through which coolant is injected and an outlet 137 through which coolant is discharged. Coolant here means a liquid or fluid for cooling heat.

In another embodiment, the first side end portion 131 may include an inlet 136 through which coolant is injected. The second side end portion 132 may include an outlet 137 through which coolant is discharged.

The at least one plate 130 may include any one of an inlet 136 through which fluid is injected into any one of the first side end portion 131 and the second side end portion 132 and an outlet 137 through which fluid is discharged.

In an embodiment, the inlet 136 and the outlet 137 may be formed in the first side end portion 131. The flow path may include a first flow path 135a in communication with the inlet 136 and moving fluid from the first side end portion 131 toward the second side end portion 132 and a second flow path 135b in communication with the first flow path 135A and the outlet 137 to move fluid.

In an embodiment, the inlet 136 and the outlet 137 may each be connected with a tube 146, 147. For example, tubes 146 and 147 may be connected to the inlet and outlet of other plates. In embodiments, the tubes 146, 147 may include at least one material of silicone and rubber. In an embodiment, at least one of the inlet 136 and the outlet 137 may be a Y-type, T-type nipple or the like.

In embodiments, each of the inlet 136 and outlet 137 may be connected with a supply line and an outlet line.

The supply pipe may supply fluid to the inlet 136, and the discharging pipe may move fluid discharged from the outlet 137.

When the at least one plate 130 is formed as a plurality of plates, the plurality of plates 130 may be connected to the supply pipe and the discharging pipe at the same time. The supply pipe and the discharging pipe may pass through a partial area of the plurality of plates 130.

As the first side end portion 131, the second side end portion 132, and the cooling portion 135 are formed of a metal material, some regions may be insulated. The first side end portion 131 and the second side end portion 132 may be insulated except for a portion connected to the first tab 111 or the second tab 112.

The cooling portion 135 in contact with the body portion 115 of the battery cell 110 may be insulated.

The cooling portion 135 may not be electrically connected through contact with the body 115 of the battery cell 110. That is, the cooling portion 135 may be electrically connected to the battery cell 110 through the first side end portion 131 or the second side end portion 132 connected to the first tab 111 or the second tab 112 of the battery cell 110.

In the cooling portion 135, the first tab 111 or the second tab 112 of the battery cell 110 facing at least one side of two sides of each plate of the plurality of plates 130 may be electrically connected.

At the first side end portion 131 or the second side end portion 132, the first tab 111 or the second tab 112 of the battery cell 110 facing at least one side of each plate side of the plurality of plates 130 may be electrically connected.

The cooling portion 135 may contact the body 115 of the battery cell 110 to cool the battery cell 110.

In one embodiment described above, the first side end portion 131, the second side end portion 132, and the cooling portion 135 may be formed of a metallic material including aluminum.

In other embodiments, the first side end portion 131, the second side end portion 132, or the cooling portion 135 of the plate 130 may be formed of a non-metallic material. For example, the first side end portion 131 and the second side end portion 132 may be formed of a metallic material, while the cooling portion 135 may be formed of non-metallic material including plastic. Alternatively, the cooling portion 135 may be formed of a metallic material, but the first side end portion 131 and the second side end portion 132 may be formed of non-metallic material including plastic.

In order to connect the first side end portion 131 and the second side end portion 132 to the cooling portion 135, bonding of a metallic material and a non-metallic material may be required. Joining between dissimilar materials may be necessary to complete the plate 130.

The metallic material and the non-metallic material may be bonded to each other by subjecting the metallic material to a surface treatment to form fine pores on the surface of the metallic material, and then allowing the adhesive to flow. It can be bonded to non-metallic materials through adhesives present in the pores formed on the metal surface. Alternatively, the metallic material and the non-metallic material may be joined by bolts or the like.

When the first side end portion 131 and the second side end portion 132 are formed of a non-metallic material, the busbars may be disposed adjacently. The battery cell 110 and the busbar adjacent to the first side end portion 131 or the second side end portion 132 may be electrically connected.

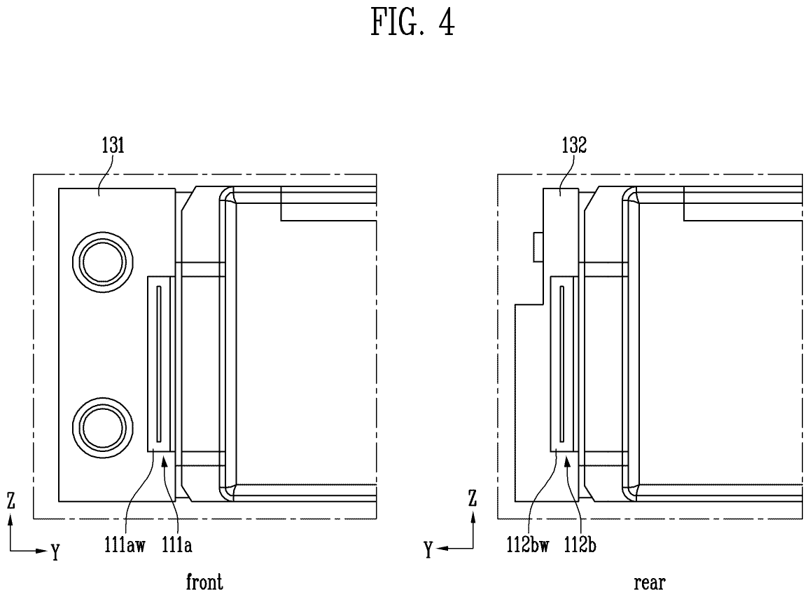

FIG. 4 is a diagram illustrating a combination of a battery cell and a plate according to an embodiment.

Referring to FIGS. 1 and 4, according to an embodiment, the first tab 111a of one battery cell 110a may be welded to the first side end portion 131 so as to be electrically connected to the first side end portion 131 of the plate 130. For example, in a state where the first positive electrode connecting portion 111aw of the first tab 111 is superimposed on the front end of the first side end portion 131, the front end of the first positive electrode connecting portions 111aw may be melted and solidified to be welded. In this case, welding can be performed by various methods such as laser welding, friction stir welding, brazing welding, resistance welding, and ultrasonic welding.

According to an embodiment, the second tabs 112b of the other battery cells 110b may be welded to the second side end portion 132 to be electrically connected to the second side end portion 132 of the plate 130.

For example, in a state where the second negative electrode connecting portion 112bw of the second tab 112b is superimposed on the rear end of the second side end portion 132, the rear end portion of the second negative electrode connecting portion 112bw may be melted and solidified to be welded. In this case, welding can be performed by various methods such as laser welding, friction stir welding, brazing welding, resistance welding, and ultrasonic welding.

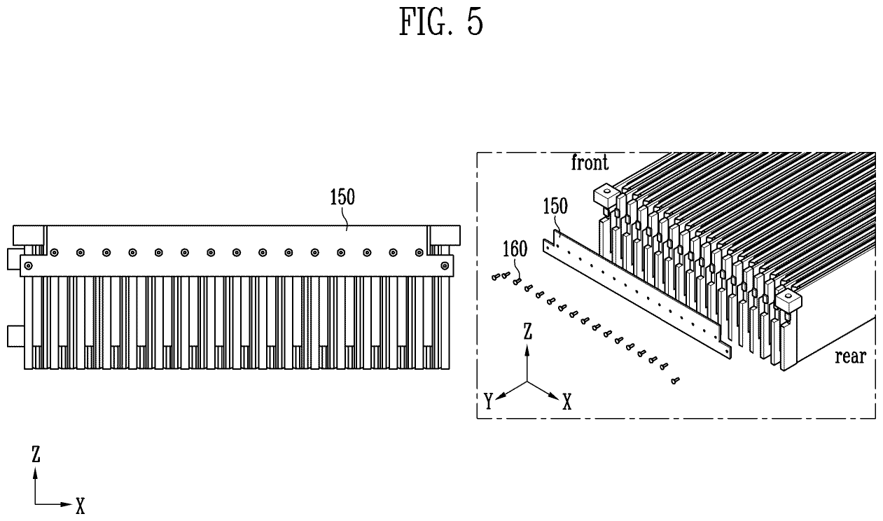

FIG. 5 is a diagram illustrating a sensing terminal according to an embodiment.

Referring to FIGS. 1 and 5, the sensing terminal 150 according to an embodiment may be coupled to the plate 130 to be electrically connected to the plate 130. The sensing terminal 150 may measure the voltage or current of one battery cell 110a and another battery cell 110b. The sensing terminal 150 may measure the voltage or current of one battery cell 110a and another battery cell 110b through an electrically connected plate 130. In an embodiment, the sensing terminal 150 may measure the temperature of one battery cell 110a and another battery cell 110b.

The sensing terminal 150 may detect thermal runaway of the plurality of battery cells 110 by communicating with a separate sensor that detects the presence or absence of gas generation or pressure in a space including the plurality of battery cell 110.

In an embodiment, the sensing terminal 150 may be coupled to the at least one plate 130 via a fixing member 160. For example, the fixing member 160 may be a member such as a screw or a bolt. In an embodiment, the sensing terminal 150 may be electrically connected to the plate 130 through the fixing member 160. The fixing member 160 may include a conductive material.

For example, the sensing terminal 150 may include a printed circuit board for measuring the voltage of the plate 130. A through hole is formed in the printed circuit board, and an exposed terminal may be formed around the through hole. The fixing member 160 may be inserted into the through hole and come into contact with the terminal. In another embodiment, the sensing terminal 150 may be coupled to the at least one plate 130 via welding.

In an embodiment, the sensing terminal 150 may be disposed at one side end of the at least one plate 130. According to the present disclosure, the plate 130 may function as a busbar, and the sensing terminal 150 disposed at the side end may be electrically connected to all the battery cells 110 in the battery assembly 100. This structural arrangement can improve spatial efficiency.

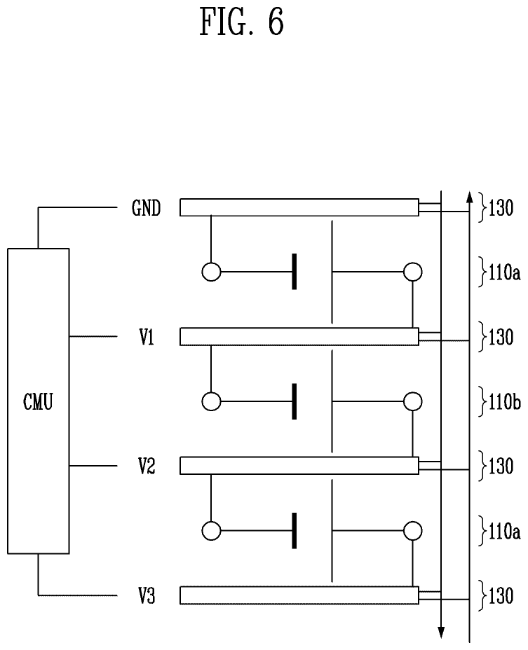

FIG. 6 is a diagram illustrating a connection relationship between battery cells according to an embodiment.

Referring to FIGS. 1 and 6, one battery cell 110a and another battery cell 110b according to an embodiment of the present disclosure may be connected in series through a plate 130. That is, a plurality of battery cells 110 of the present disclosure may be connected in series through a plate 130 disposed therebetween. The sensing terminal 150 may be electrically connected to each plate 130 to measure individual voltages V1 to V3 between the plurality of battery cells 110.

The battery assembly 100 may include a plurality of battery cells 110 and a plurality of plates 130. The plurality of battery cells 110 and the plurality of plates 130 may be stacked in the first horizontal direction. One plate may be arranged between the plurality of battery cells 110. In an embodiment, an additional plate may be disposed on the outermost side of the plurality of battery cells 110.

In an embodiment, the plurality of battery cells 110 may include a first battery cell, a second battery cell, and a third battery cell sequentially arranged in a first horizontal direction. The plurality of plates 130 may include a first plate, a second plate, a third plate, and a fourth plate sequentially disposed in a first horizontal direction.

The first plate may be disposed outside the first battery cell. The second plate may be arranged between the first and second battery cells. The third plate may be arranged between the second and third battery cells. The fourth plate may be disposed outside the third battery cell.

The negative electrode tab of the first battery cell may be electrically connected to the first side end portion of the first plate. The negative electrode tab of the second battery cell may be electrically connected to the first side end portion of the second plate, and the positive electrode tab of the first battery cell may be electrically connected to the second side end portion of the first plate. The negative electrode tab of the third battery cell may be electrically connected to the first side end portion of the third plate, and the positive electrode tab of the second battery cell may be electrically connected to the second side end portion of the second plate. The positive tab of the third battery cell may be electrically connected to the second side end portion of the fourth plate. In this case, the first to third battery cells may be connected in series through a plurality of plates.

The sensing terminal 150 may be electrically connected to one of the side ends of each of the plurality of plates. For example, the sensing terminal 150 may be electrically connected to a first side end portion of each of the first through fourth plates. For another example, the sensing terminal 150 may be electrically connected to a second side end portion of each of the first through fourth plates. According to an embodiment of the present disclosure, the sensing terminal 150 may be located adjacent to one of the side ends, and thus space efficiency may be improved.

In addition, as shown in FIG. 6, one plate 130 arranged between one battery cell 110a and another battery cell 110b may be electrically connected to the first tab 111a of one battery cell 110A on one side and electrically connected to the second tab 112b of another battery cell 110B on the other side of the two sides formed along the stacking direction.

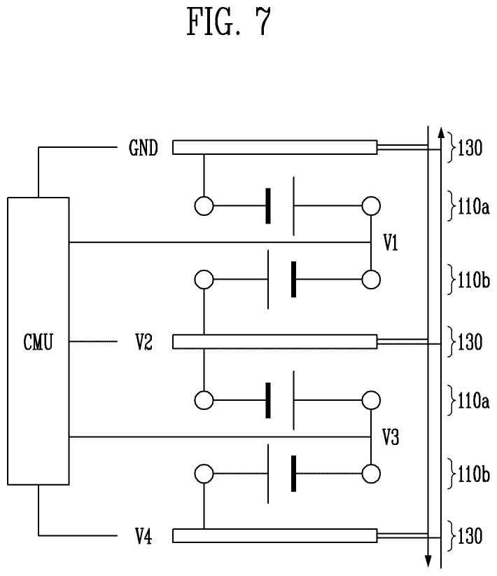

FIG. 7 is a diagram illustrating a connection relationship between battery cells according to another embodiment.

As shown in FIG. 7, the second tab 112a of one battery cell 110a and the first tab 111b of another battery cell 110b may be electrically connected, the first tab 111a of one battery cells 110a may be connected to one plate, and the second tab 112b of another battery cells 110b may be connected to the next stacked plate.

In addition, as shown in FIG. 6 and FIG. 7, at least one plate of a battery assembly according to an embodiment of the present disclosure and another embodiment may be electrically connected to a first tab or a second tab of the battery cell facing at least one side of two sides of the plate at a side end.

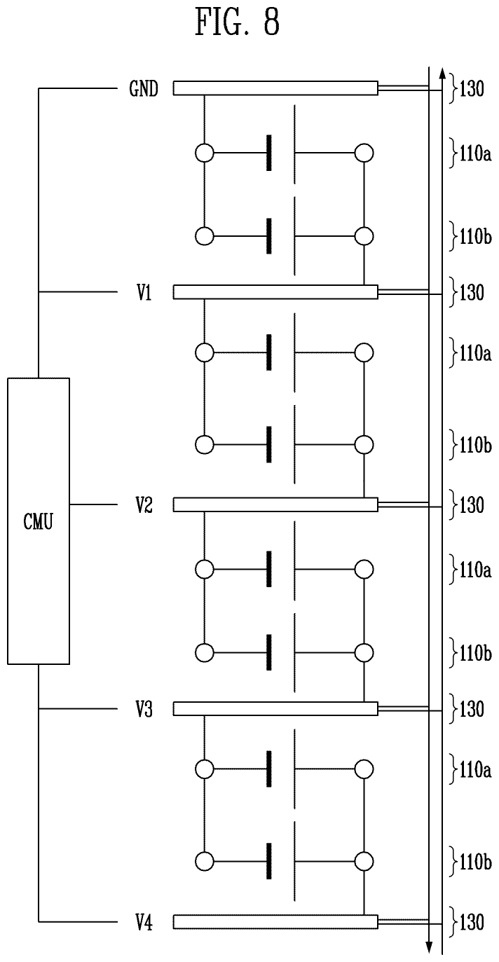

FIG. 8 is a diagram illustrating a connection relationship between battery cells according to another embodiment.

As shown in FIG. 8, a plurality of first tabs 111 of a plurality of battery cells arranged in parallel are connected to one plate, and a plurality of second tabs 112 of a plurality of the battery cells are connected to the next stacked plate.

In addition, at least one plate of the battery assembly according to another embodiment of the present invention may be electrically connected to the first tab or the second tab of the battery cell facing at least one side of two sides of the plate at the cooling portion.

FIGS. 6 to 8 described above relate to various embodiments in which a single battery cell 110 is arranged between the plates 130, and the connection relationship between the battery cell 110 and the plates 130 is not limited thereto.

For example, two battery cells 110 may be arranged between the plates 130. Each of the two battery cells 110 may have at least one of its two sides in contact with the plate 130. The two battery cells 110 may be electrically connected to each other through a first tab 111 or a second tab 112, and the remaining tabs may be electrically connected between the two battery cells 110.

For example, the first battery cell and the second battery cell may be sequentially arranged between the first plate and the second plate. A first battery cell may be arranged between the first plate and the second battery cell, and a second battery cell may be arranged between the first battery cell and the second plate. The body portion 115 of the first battery cell is in contact with the cooling portion 135 of the first plate, and the body portion 115 of a second battery cell may be in contact with the cooling portion 135 of the second plate.

A first tab 111 of the first battery cell may be electrically connected to the first plate, and a second tab 112 of a second battery cell may be electrically connected to the second plate. The second tab 112 of the first battery cell and the second tab 112 of a second battery cell may be electrically connected to each other.

Alternatively, the first plate, the first tab 111 of the first battery cell, and the first tab 111 of the second battery cell may be electrically connected, and the second plate, the second tab 112 of the first battery cells, and the second tab 112 of the second batteries may be electrically connected.

Another embodiment may include a busbar electrically connected with the battery cell 110 and the plate 130. The busbar may be electrically connected to a plurality of battery cells 110 and a plurality of plates 130. The busbar may be disposed adjacent to the first tab 111 or the second tab 112 of the battery cell 110. One busbar may be electrically connected to the first tabs 111 of the plurality of battery cells 110, and the other busbar may be electronically connected to the second tabs 112 of the plurality of the battery cells 110.

One busbar and another busbar may be electrically connected to the same battery cell 110 or plate 130. The busbar may include a conductive material such as aluminum or copper. The sensing terminal 150 may be connected to a busbar.

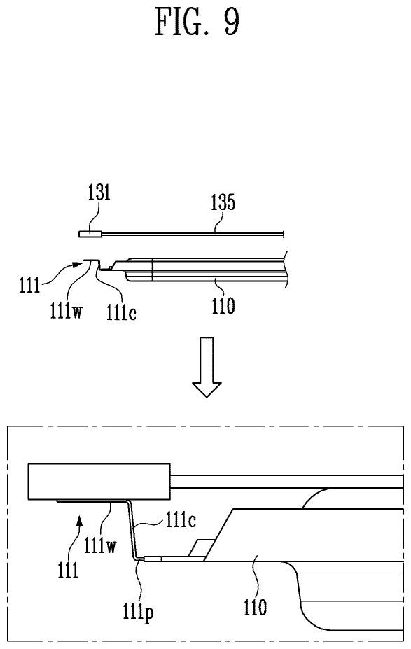

FIG. 9 is a schematic diagram illustrating a connection relationship between a battery cell and a side end portion according to another embodiment.

As shown in FIG. 9, the first tab 111 may include a first bending portion 111c, at least a portion of which is bent toward one side of one plate 130 of the at least one plate 130, and a first connecting portion 111w, which is bent at the first folded portion 111c and extends in parallel with the one side of the one plate 130.

In addition, a first connecting portion 111w extending parallel to one side may be connected to the first side portion 131.

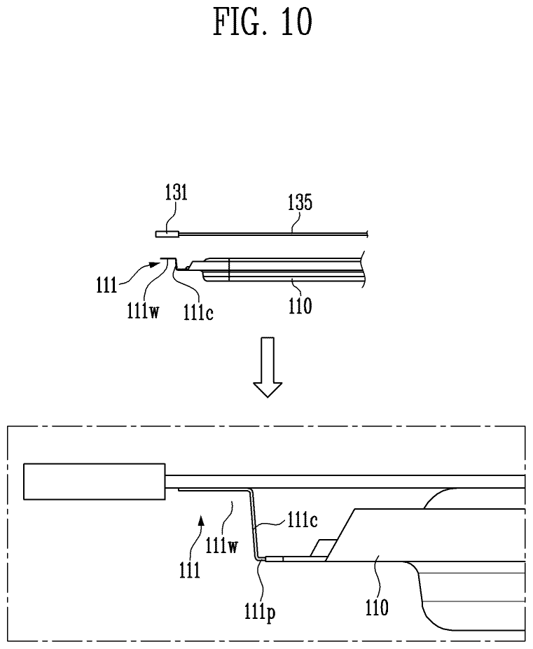

FIG. 10 is a schematic diagram illustrating a connection relationship between a battery cell and a cooling portion according to another embodiment.

As shown in FIG. 10, the first tab 111 may include a first bending portion 111c, at least a portion of which is bent toward one side of one plate 130 of the at least one plate 130, and a first connecting portion 111w, which is bent at the first folded portion 111c and extends in parallel with the one side of the one plate 130.

In addition, a first connecting portion 111w extending in parallel with one side may be connected to the cooling portion 135.

According to the embodiment of the present disclosure as described above, the thermal stability of the battery assembly 100 can be improved.

According to an embodiment of the present disclosure, the cooling performance of the battery assembly 100 may be improved. According to an embodiment of the present disclosure, the performance of the battery assembly 100 may be improved according to the cooling performance. According to an embodiment of the present disclosure, a contact area for cooling the battery cell 110 may be improved. According to an embodiment of the present disclosure, it is possible to minimize a decrease in the density of the battery cells 110 in the battery assembly 100 in order to cool the battery cells 110.

The above description of the present disclosure is for illustrative purposes only, and a person skilled in the art to which the present disclosure pertains will understand that the present disclosure may be easily modified into other specific forms without changing the technical idea or essential features of the present disclosure. Therefore, it should be understood that the embodiments described above are exemplary in all respects and not limiting. For example, each component described as a single entity may be implemented in a distributed manner, and likewise, components described as distributed may be implemented in a combined manner.

The scope of the present disclosure is indicated by the appended claims rather than the detailed description above, and all changes or modifications derived from the meaning and scope of the claims and their equivalent concepts should be construed as being included in the scope of the present disclosure.

What is claimed is:

1. A battery assembly comprising:
a plurality of battery cells, each of which includes a first tab and a second tab, arranged along a predetermined stacking direction;
at least one plate arranged between the plurality of battery cells; and
a flow path formed inside at least one plate through which fluid moves
wherein the at least one plate is electrically connected to a battery cell facing at least one side among the two sides including one side and the other side respectively formed along the predetermined stacking direction.

2. The battery assembly according to claim 1, wherein the at least one plate is connected to a first tab of a battery cell facing one side of the two sides or a first tab of a battery cell facing the other side of the two sides, or a second tab of a battery cell facing one side of the two sides or a second tab of a battery cell facing the other side of the two sides.

3. The battery assembly according to claim 1, wherein the at least one plate includes a cooling portion in which the flow path is formed and side portions positioned at both ends of the cooling portion.

4. The battery assembly according to claim 3, wherein the at least one plate is electrically connected to the first tab or the second tab of the battery cell facing at least one side of the two sides at the cooling portion.

5. The battery assembly according to claim 3, wherein the at least one plate is electrically connected to the first tab or the second tab of the battery cell facing at least one side of the two sides at the side portion.

6. The battery assembly according to claim 3, wherein each of the plurality of battery cells includes a body portion to which the first tab and the second tab are respectively connected and in which the electrode assembly is accommodated,
wherein at least one side of two sides of the body portion formed along the stacking direction is in contact with the at least one plate.

7. The battery assembly according to claim 6, wherein the body portion is contact with the cooling portion of the at least one plate.

8. The battery assembly according to claim 6, wherein at least one surface in contact with at least one plate in the body portion is insulated.

9. The battery assembly according to claim 6, wherein the side portion includes a first side end portion formed at one side end along a direction perpendicular to the stacking direction and a second side end portion formed at the other side end facing the one side end.

10. The battery assembly according to claim 9, wherein the cooling portion is formed between the first side end portion and the second side end portion.

11. The battery assembly according to claim 9, wherein one of the first side end portion and the second side end portion of the at least one plate includes one of an inlet through which the fluid is injected and an outlet through which the fluid is discharged.

12. The battery assembly according to claim 11, wherein the inlet and the outlet are formed at the first side end portion, and the flow path includes a first flow path communicating with the inlet and moving the fluid from the first side end portion toward the second side end portion and a second flow path that communicates the first flow path and the outlet to move the fluid.

13. The battery assembly according to claim 7, further comprising:
a supply pipe for supplying the fluid to the inlet; and
a discharging pipe for moving the fluid discharged from the outlet.

14. The battery assembly according to claim 13, wherein the at least one plate is formed of a plurality of plates, and the plurality of plates are connected to the supply pipe and the discharging pipe.

15. The battery assembly according to claim 9, wherein the first tab includes a first bending portion, at least a portion of which is bent toward one side of one of the at least one plates and a first connecting portion that is bent at the first bending portion and is extended in parallel with one side of the plate.

16. The battery assembly according to claim 15, wherein the first connecting portion is electrically connected to one side of the plate.

17. The battery assembly according to claim 15, wherein the second tab includes a second bending portion, at least a portion of which is bent in a direction opposite to the direction in which the first bending portion is bent and a second connecting portion which is bent in the second bending portion in a direction opposite to the first connecting portion and is extended parallel to the one side of the plate.

18. The battery assembly according to claim 17, wherein the second connecting portion is electrically connected to the other side of the other of the at least one plate.

19. The battery assembly according to claim 1, further comprising:
a sensing terminal coupled to the at least one plate to be electrically connected to the at least one plate and be configured to sense voltages or currents of the plurality of battery cells.

20. The battery assembly according to claim 19, wherein the sensing terminal detects the temperature of the plurality of battery cells, communicates with a sensor that detects the presence or absence of gas generation or pressure in a space where the plurality of battery cells are arranged, and detects thermal runaway of the plurality of battery cells.
